(19) United States
(12) Patent Application Publication
(10) Pub. No.: US 2004/0117229 A1
(43) Pub. Date: Jun. 17, 2004

(54) System and method of automated repair and control operation

(76) Inventors: Wen-Bin Chung, Taipei Hsieng (TW); Han-Cheng Lai, Taipei Hsieng (TW); Shih-Chi Pan, Taipei Hsieng (TW)

Correspondence Address: BIRCH STEWART KOLASCH & BIRCH, PO BOX 747, FALLS CHURCH, VA, 22040-0747, US

(21) Appl. No.: 10/730,085

(22) Filed: Dec. 9, 2003

(30) Foreign Application Priority Data
Dec. 3, 2002 (TW) 91135060

(51) Int. Cl. G06F 17/60

(52) U.S. Cl. 705/7

(57) ABSTRACT

A system and method of automated repair and control operation. First, RMA numbers are generated after RMA request forms for returned product are received. RMA data for the returned product is uploaded to a database of a factory information system and is then verified for accuracy. Next, it is determined whether claimed defects of the returned product are accurate and the returned product are repaired accordingly. Returned product are inspected again to confirm the repairing step is complete, and finally, packaged and shipped.

### BACKGROUND OF THE INVENTION

1. Field of the Invention

The present invention relates to a system and method of automated operation, and in particular to a system and method of automated repair and control operation.

2. Description of the Related Art

A factory information system (FIS) for returned merchandise authorization (RMA) performs repair and control procedures for defective products.

Manufacturers repairs returned defective products by which related RMA data is manually recorded and calculated, a time-consuming and inconvenient operation. RMA reports assist in research and development and design if recorded automatically in a database during repair processes, thereby enhancing product reliability, increasing Mean Time Between Failure (MTBF), and improving customer satisfaction.

### SUMMARY OF THE INVENTION

Accordingly, an object of the present invention is to provide a system and method of automated repair and control operation for return defective products.

According to the object described, the present invention provides a system and method of automated repair and control operation for return defective products. First, Returned Merchandise Authorization (RMA) numbers are generated when RMA request forms for returned merchandise are received. Data of returned merchandise is uploaded to a database of a factory information system and is then verified.

Next, it is determined whether claimed defects of returned merchandise are accurate and repairs performed accordingly. Repaired products again inspected prior to being packaged and shipped.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing the interface of a factory information system of the present invention;

FIG. 2 is a schematic diagram showing the RMA NO Generation interface of the present invention;

FIG. 3 is a schematic diagram showing an RMA NO setup table of the present invention;

FIG. 4 is a schematic diagram showing RMA NO information for returned merchandise of the present invention;

FIG. 5 is a schematic diagram showing an inquiry section of the present invention;

FIG. 6 is a schematic diagram showing a date display section of the present invention;

FIG. 7 is a schematic diagram showing an RMA data table within a period of the present invention;

FIG. 8 is a schematic diagram showing an RMA data editing section of the present invention;

FIG. 9 is a schematic diagram showing an RMA request form of the present invention;

FIG. 10 is a schematic diagram showing data conversion for an RMA request form of the present invention;

FIG. 11 is a schematic diagram showing the Uploading interface of the present invention;

FIG. 12 is a schematic diagram showing an RMA Upload section of the present invention;

FIG. 13 is a schematic diagram showing file selection in RMA Uploading of the present invention;

FIG. 14 is a schematic diagram showing file upload in RMA Uploading of the present invention;

FIG. 15 is a schematic diagram showing an RMA data table in RMA Uploading of the present invention;

FIG. 16 is a schematic diagram showing an RMA data table in RMA Uploading of the present invention;

FIG. 17 is a schematic diagram showing an RMA Inquiry section in RMA Uploading of the present invention;

FIG. 18 is a schematic diagram showing an RMA data table in RMA Uploading of the present invention;

FIG. 19 is a schematic diagram showing the QC Data Sorting interface of the present invention;

FIG. 20 is a schematic diagram showing an RMA Inquiry section in QC Data Sorting of the present invention;

FIG. 21 is a schematic diagram showing an RMA data table for QC Data Sorting of the present invention;

FIG. 22 is a schematic diagram showing detailed descriptions of the RMA data table FIG. 21;

FIG. 23 is a schematic diagram showing a Damage Condition section in QC Data Sorting of the present invention;

FIG. 24 is a schematic diagram showing modification of damage conditions in QC Data Sorting of the present invention;

FIG. 25 is a schematic diagram showing addition of damage conditions in QC Data Sorting of the present invention;

FIG. 26 is a schematic diagram showing the Repair interface of the present invention;

FIG. 27 is a schematic diagram showing an RMA inquiry section for RMA Repair of the present invention;

FIG. 28 is a schematic diagram showing an RMA data table in RMA Repair of the present invention;

FIG. 29 is a schematic diagram showing a repair data table in RMA Repair of the present invention;

FIG. 30 is a schematic diagram showing a repair cause table for additional repair data of the present invention;

FIG. 31 is a schematic diagram showing a damage data table of FIG. 30 for data addition of the present invention;

FIG. 32 is a schematic diagram showing a damage data table for data modification of damage reasons of FIG. 30 of the present invention;

FIG. 33 is a schematic diagram showing an error message for RMA Repair of the present invention;

FIG. 34 is a schematic diagram showing an RMA data inquiry section for inquiry of flow control of the present invention;

FIG. 35 is a schematic diagram showing the result of data inquiry with flow control of FIG. 34 of the present invention;

FIG. 36 is a schematic diagram showing an RMA data inquiry section for inquiry of non-flow control of the present invention;

FIG. 37 is a schematic diagram showing the result of data inquiry with non-flow control of FIG. 36 of the present invention;

FIG. 38 is a schematic diagram showing a Quality Control Inspection interface of the present invention;

FIG. 39 is a schematic diagram showing a Quality Control Inspection section for modification of the present invention;

FIG. 40 is a schematic diagram showing a Quality Control Inspection section for RMA data inquiry of the present invention;

FIG. 41 is a schematic diagram showing detailed descriptions of the RMA data of FIG. 40 of the present invention;

FIG. 42 is a schematic diagram showing a Package Order interface of the present invention;

FIG. 43 is a schematic diagram showing a Package Order data section for modification of the present invention;

FIG. 44 is a schematic diagram showing a Package Order Inquiry section of the present invention;

FIG. 45 is a schematic diagram showing detailed descriptions of the Package Order data within a period of FIG. 44 of the present invention;

FIG. 46 is a schematic diagram showing a factory information system interface of the present invention; and

FIG. 47 is a schematic diagram showing an RMA Operation interface of the present invention.

### DETAILED DESCRIPTION OF THE INVENTION

The present invention provides a system and method of automated repair and control operation for return product authorization.

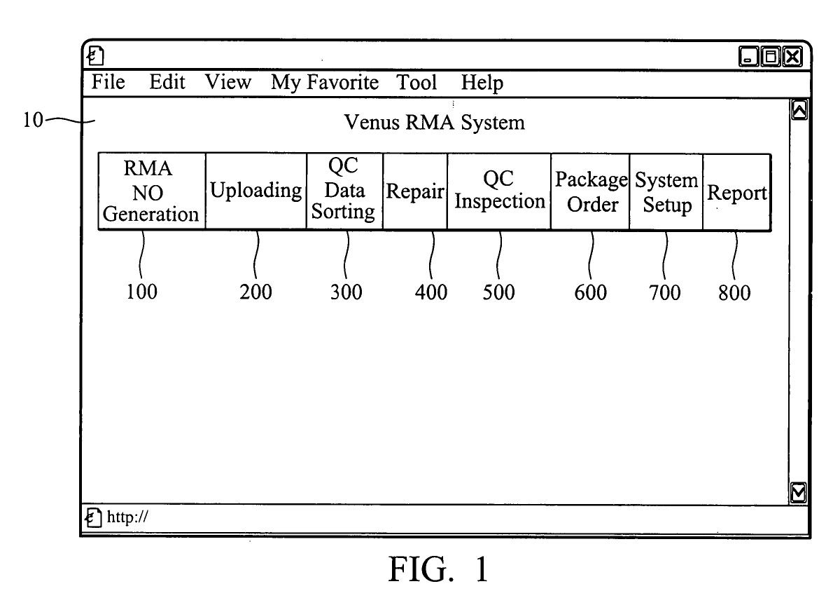

FIG. 1 is a schematic diagram showing a interface of a factory information system of the present invention. FIS interface 10 comprises an RMA NO (number) Generation label 100, an Uploading label 200, a Quality Control (QC) Data Sorting label 300, a Repair label 400, a Quality Control Inspection label 500, a Package Order label 600, a System Setup label 700, and a Report label 800.

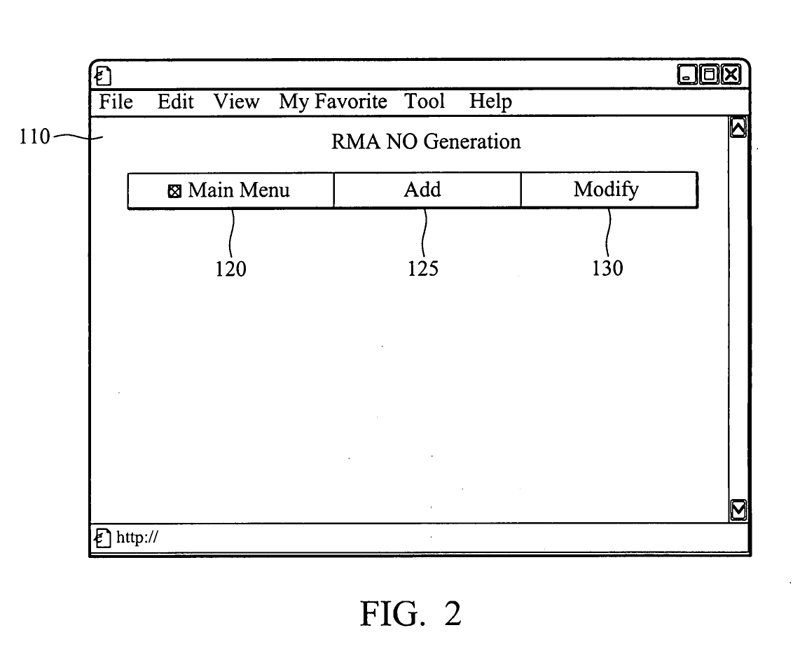

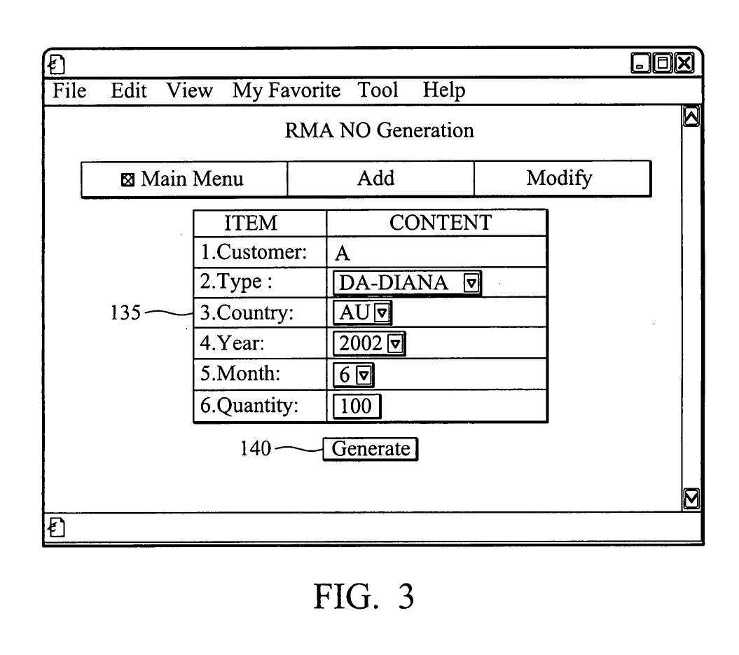

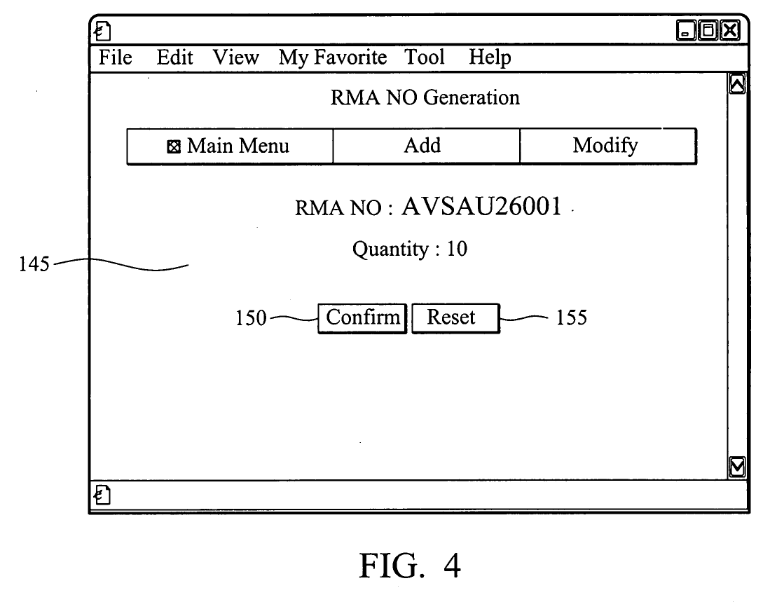

The system is a standard manufacturing process, performed when receiving RMA request forms. First, RMA NO Generation label 100 is selected to enter an RMA NO Generation interface 110, as shown in FIG. 2, comprising a Main Menu label 120, an Add label 125, and a Modify label 130. Add label 125 is selected for addition of RMA numbers, displaying an RMA data table 135 for addition, as shown in FIG. 3, which comprises a plurality of drop-down menus related to the RMA data of received returned product. A Generation button 140 is selected, displaying RMA NO information 145 of one RMA data, as shown in FIG. 4, listing the number and quantities of one request form. A Confirm button 150 is selected with correct RMA data for storage to a database and a Reset button 155 is selected with incorrect quantity to return to RMA NO setup table 135 for modification.

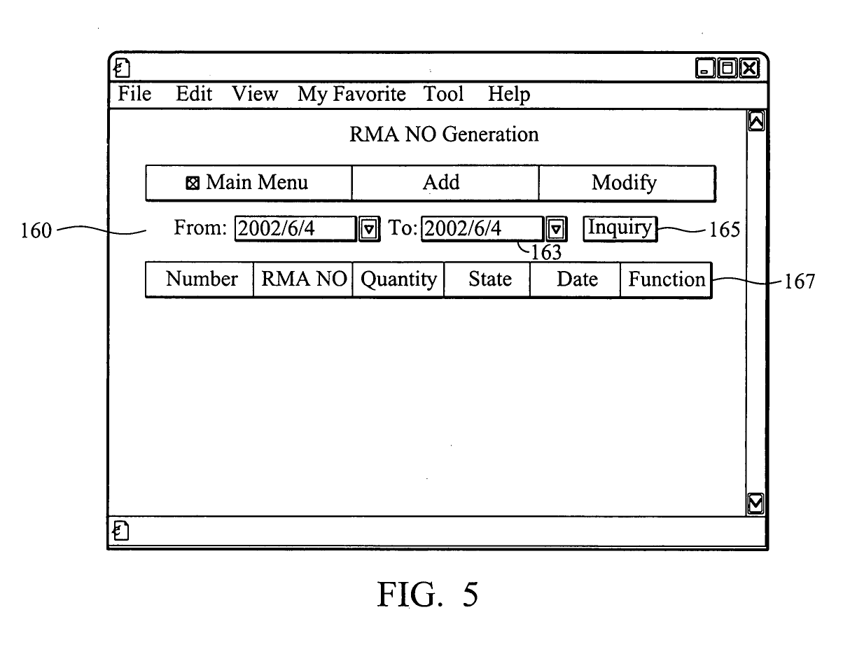

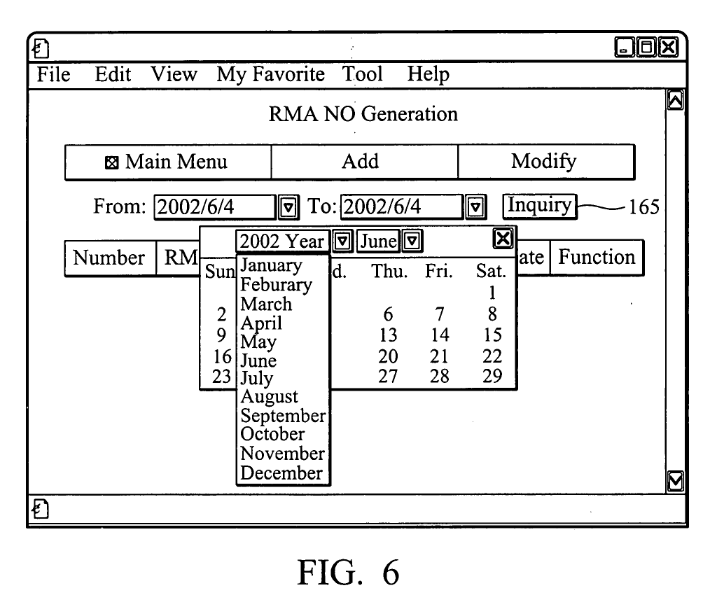

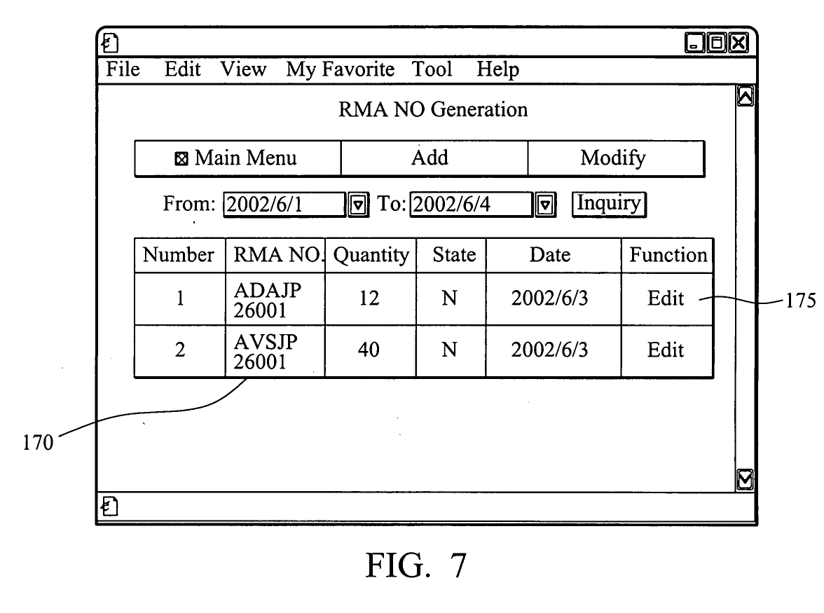

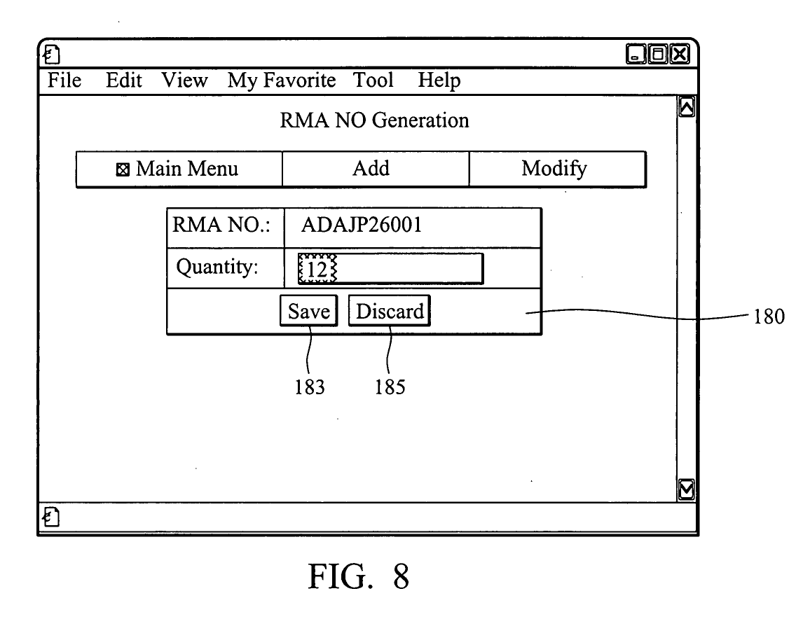

Modify label 130 is selected for modification of added RMA data, displaying an Inquiry section 160 as shown in FIG. 5, comprising a date drop-down menu 163, an Inquiry button 165, and a row of data fields 167. A date is chosen in date drop-down menu 163, as shown in FIG. 6, and Inquiry button 165 is selected, displaying an RMA data table 170, as shown in FIG. 7, listing related RMA data within a period. A Modify label 175 is selected, displaying an RMA data modification section 180, as shown in FIG. 8. A Save button 183 is selected, storing modified data to the database, and a Discard button 185 is selected without modification.

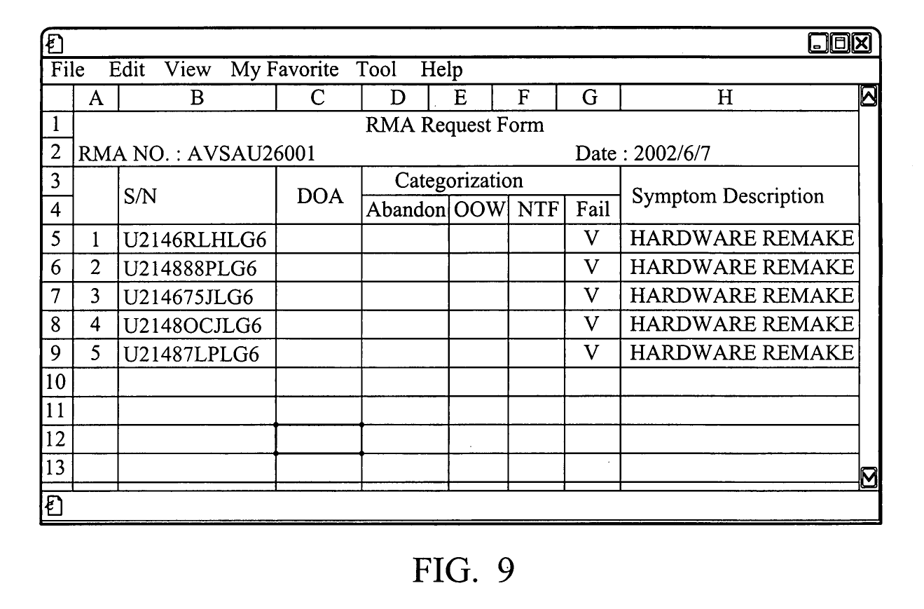

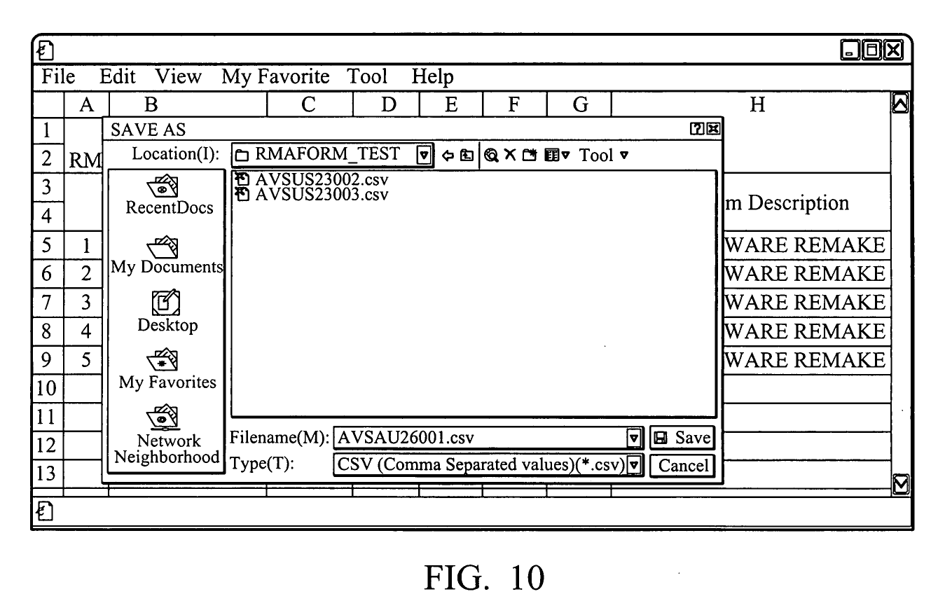

File formats of RMA data are Excel file formats (*.xls), converted as readable file formats (.csv) compatible with the factory information system, as shown in FIG. 9 and FIG. 10.

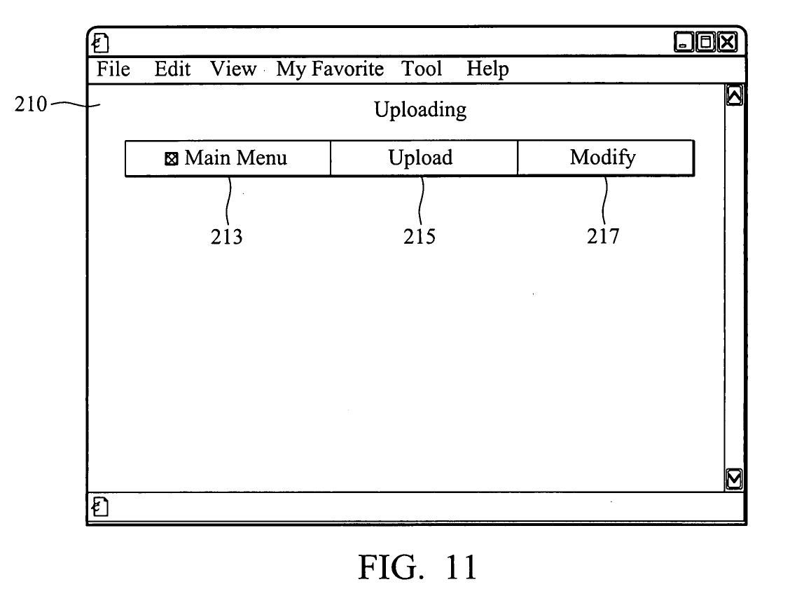

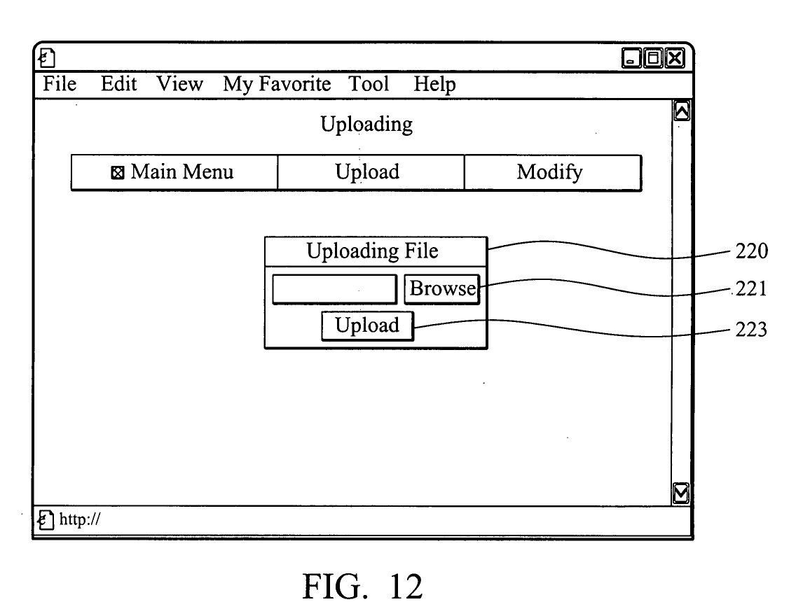

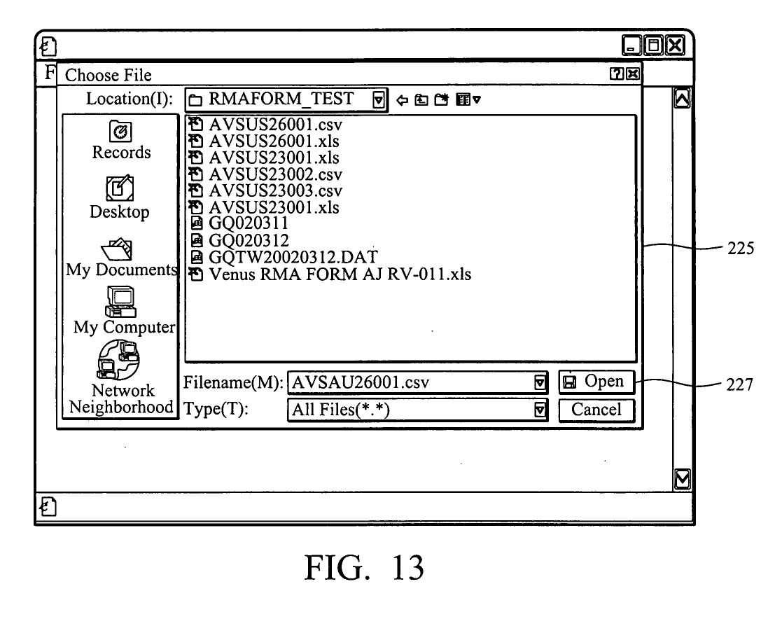

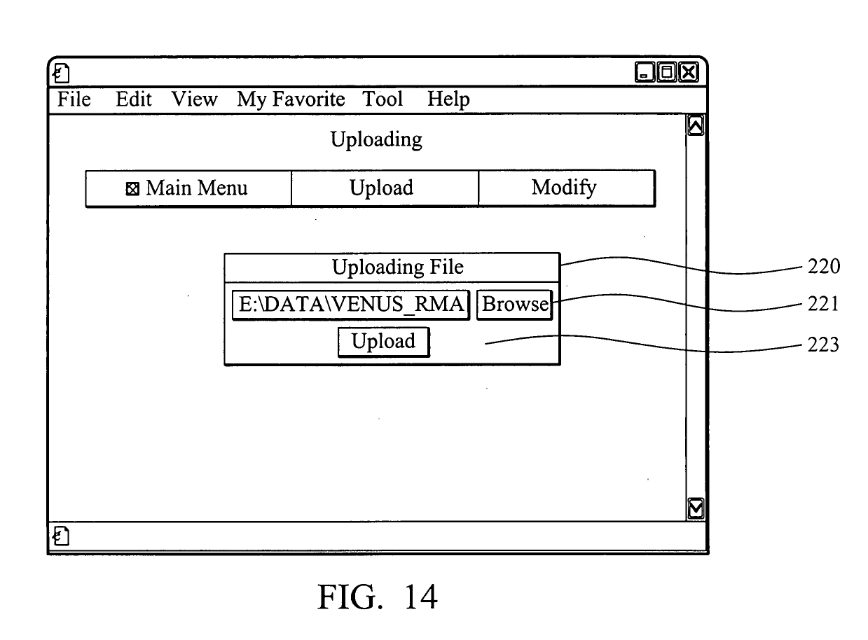

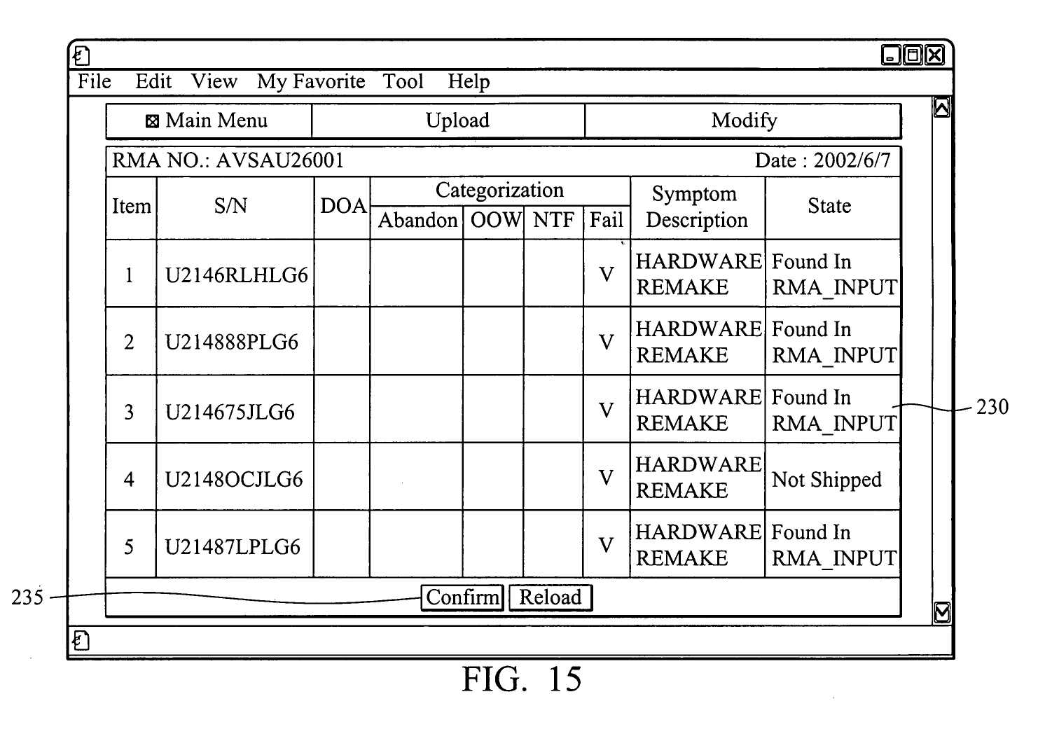

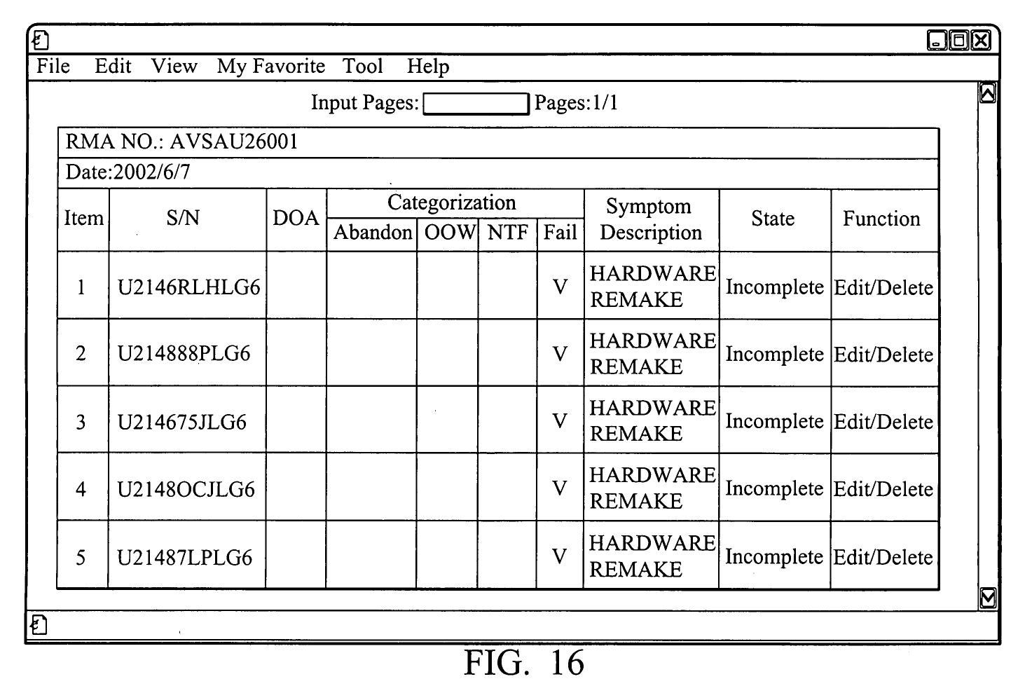

Uploading label 200 as shown in FIG. 1 is selected to enter an Upload interface 210, comprising a Main Menu label 213, an Upload label 215, and a Modify label 217, as shown in FIG. 11. Upload label 215 is selected uploading RMA data files, displaying an RMA uploading section 220, as shown in FIG. 12. A Browse button 221 is selected, displaying a File Select window 225, as shown in FIG. 13, and a desired file is then selected, and an Open 227 button is selected, filling a file path of the selected file in a browse field, as shown in FIG. 14. Next, an Upload button 223 is selected, displaying an RMA data table 230 of the selected file, as shown in FIG. 15, listing related RMA data of the selected RMA data. A Confirm button 235 is selected to upload the correct RMA data to the database, as shown in FIG. 16.

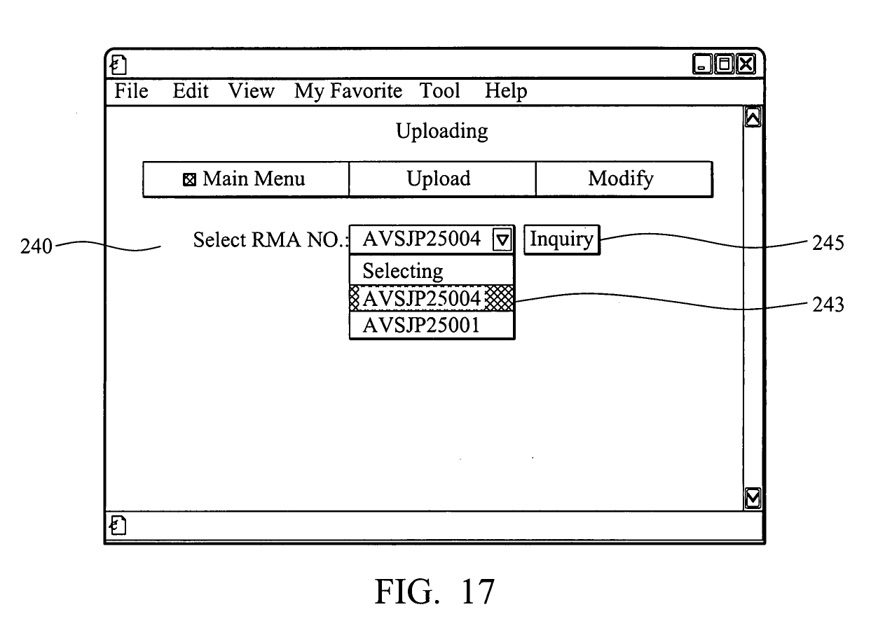

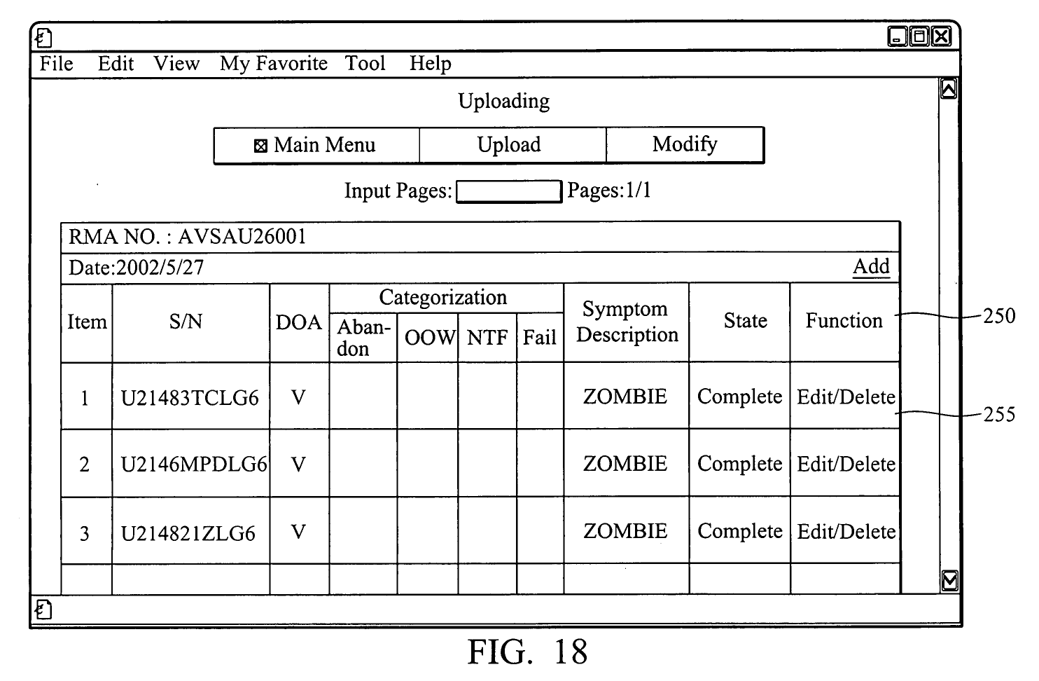

Modify label 217 as shown in FIG. 11 is selected for RMA data modification, displaying an RMA inquiry section 240, comprising an RMA NO drop-down menu 243 and an Inquiry button 245, as shown in FIG. 17. A desired RMA number in RMA NO drop-down menu 243 is selected and Inquiry button 245 is selected, displaying an RMA data table 250, as shown in FIG. 18, in which an Edit/Delete label 255 of a Function field 250 is selected for modification.

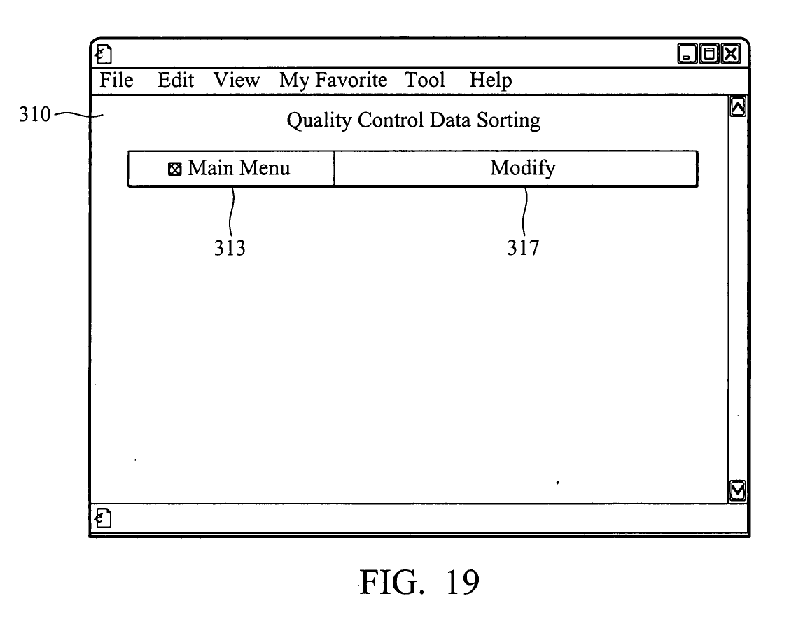

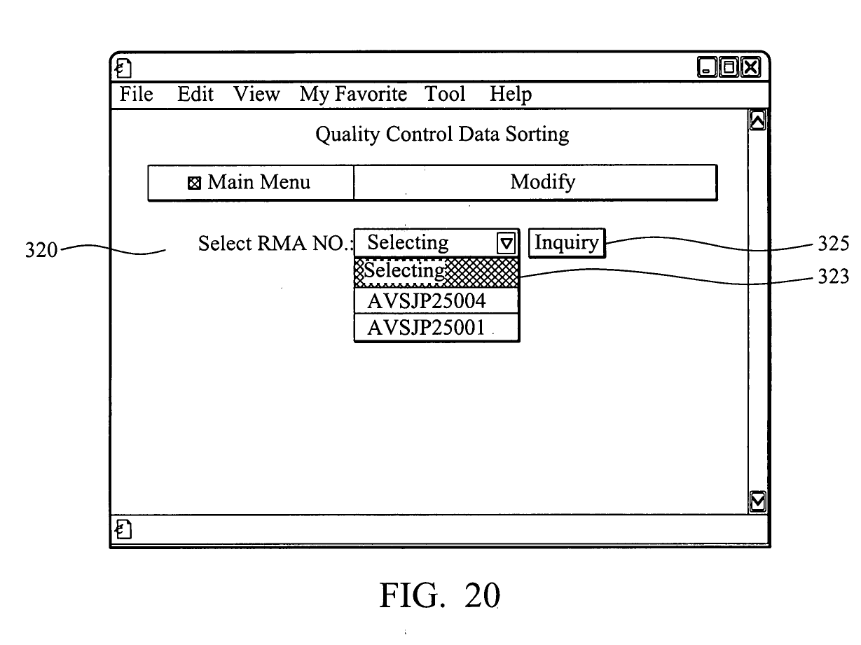

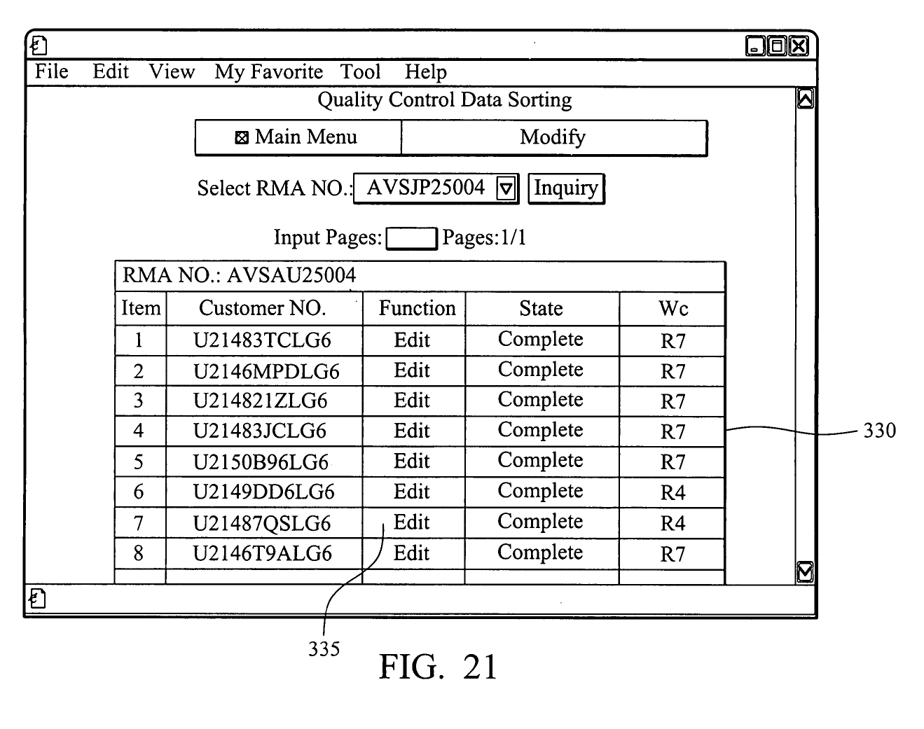

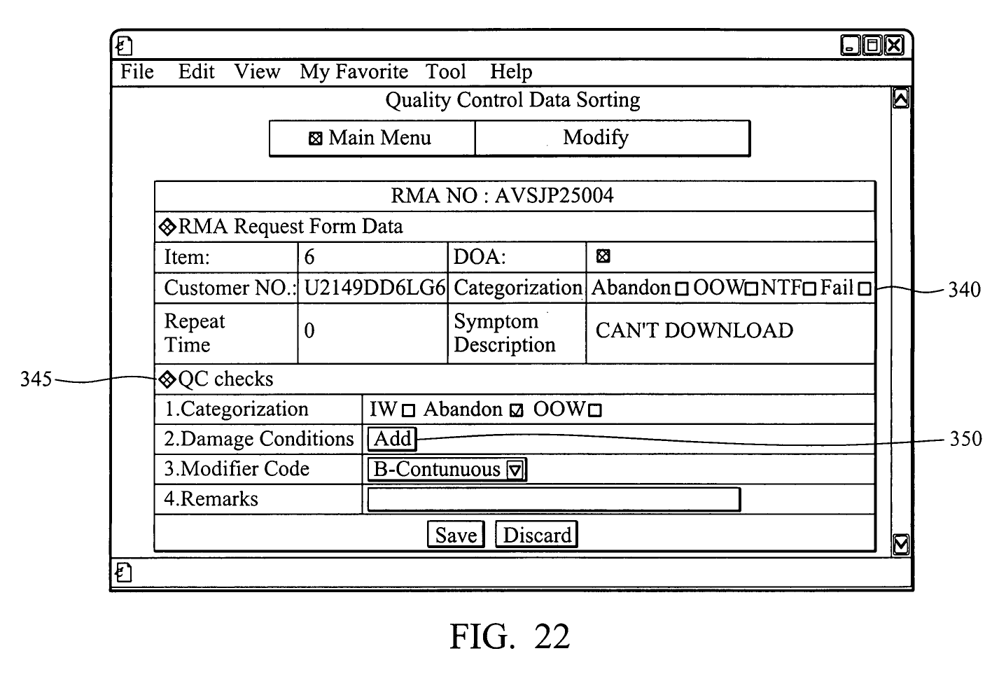

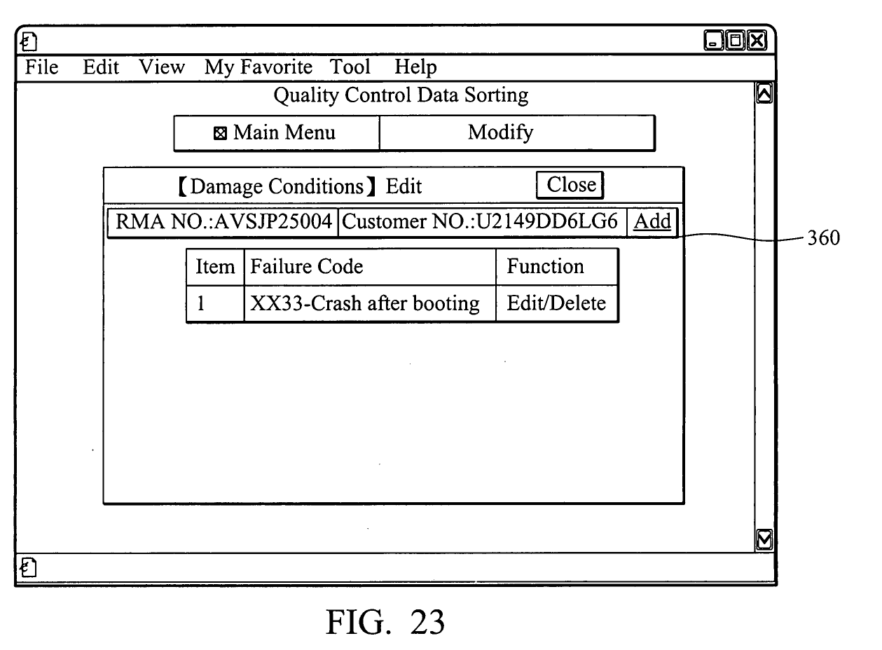

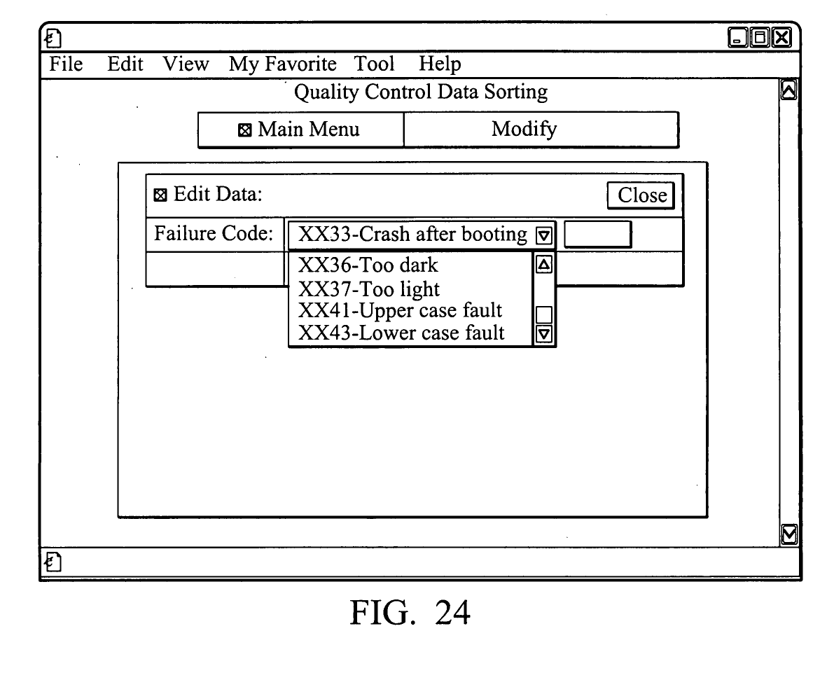

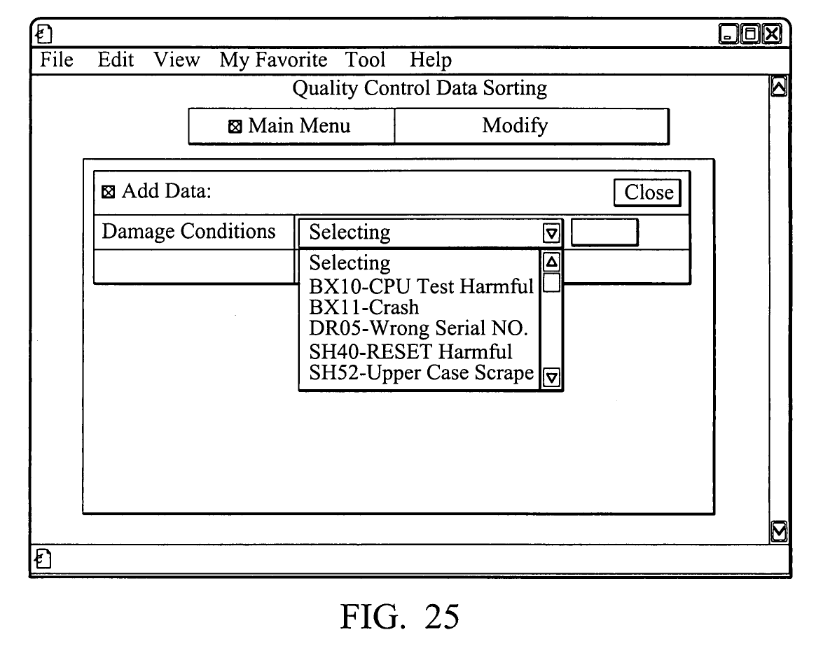

Next, QC Data Sorting label 300 as shown in FIG. 1 is selected to enter a QC Data Sorting interface 310, comprising a Main Menu label 313 and a Modify label 317, as shown in FIG. 19. Modify label 317 is selected for modification of quality control data, displaying an RMA inquiry section 320, comprising an RMA NO drop-down menu 323 and an Inquiry button 325, shown in FIG. 20. A desired RMA number from RMA NO drop-down menu 323 is selected and Inquiry button 325 is selected, displaying an RMA data table 330, as shown in FIG. 21. An Edit label 335 of a desired customer number is selected for modification, displaying an RMA data table 340, as shown in FIG. 22. To reference raw data of the RMA data table 345, fields thereof are optionally selected in accordance with real RMA conditions, in which an Add label 350 is selected with incorrect damage conditions of the raw data, displaying a Damage Condition section 360, as shown in FIG. 23, for modification and addition, as shown in FIG. 24 and FIG. 25.

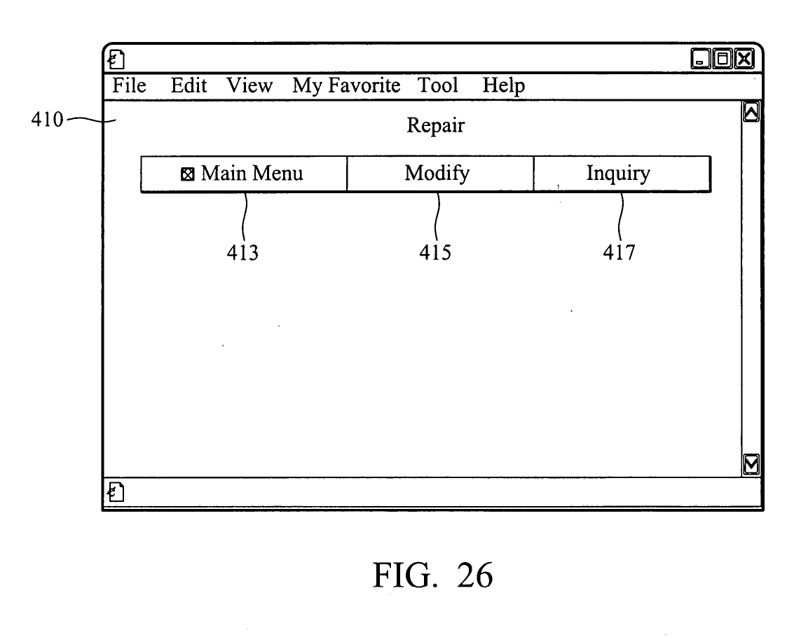

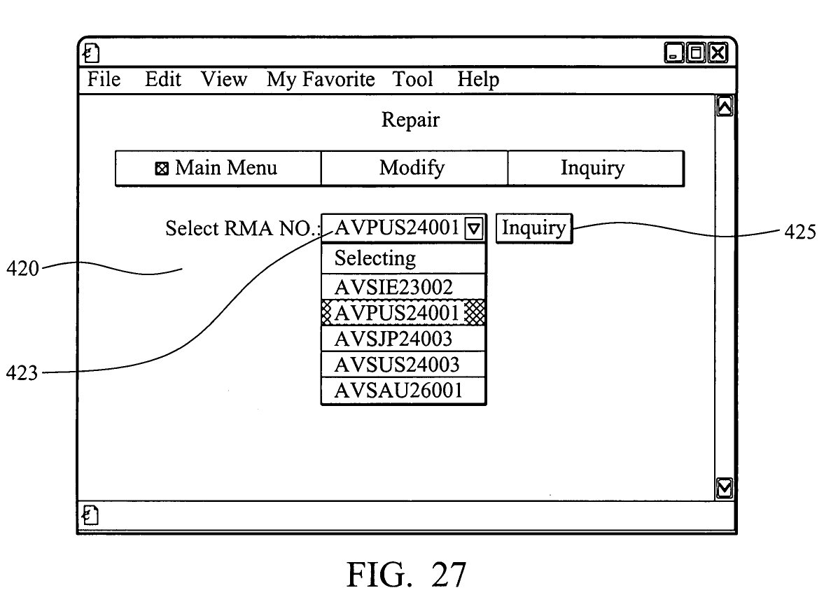

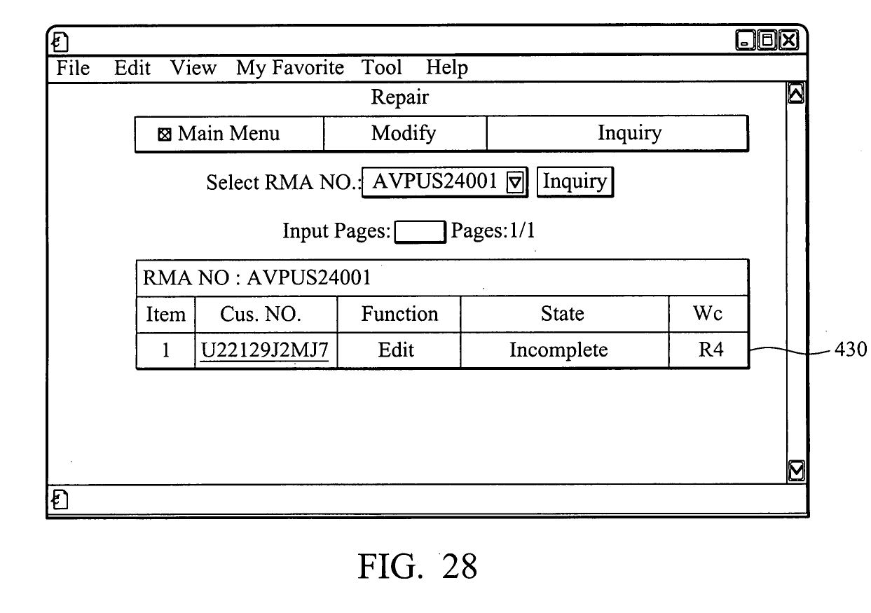

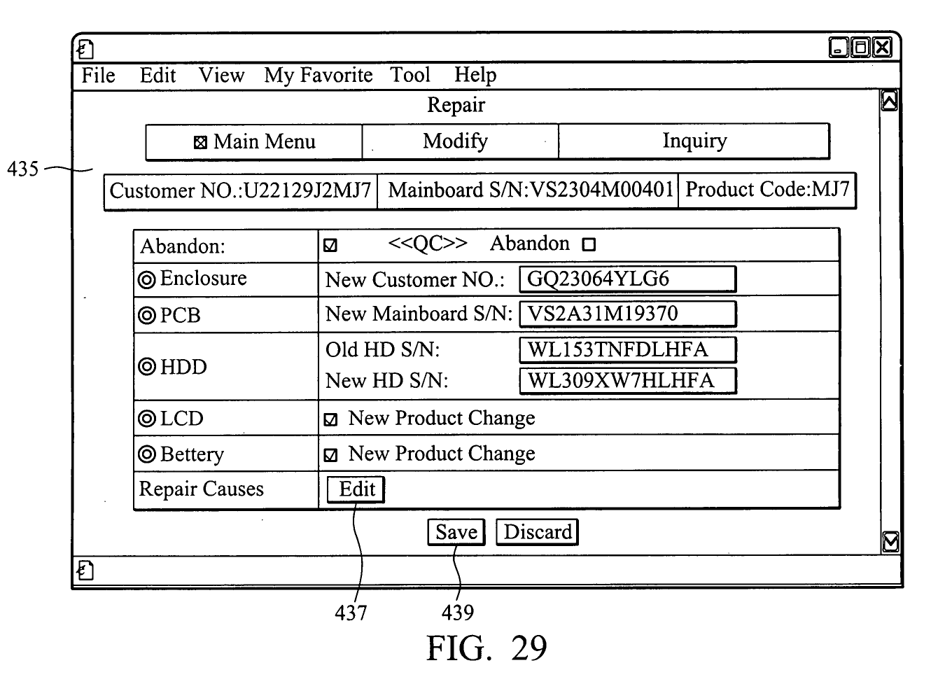

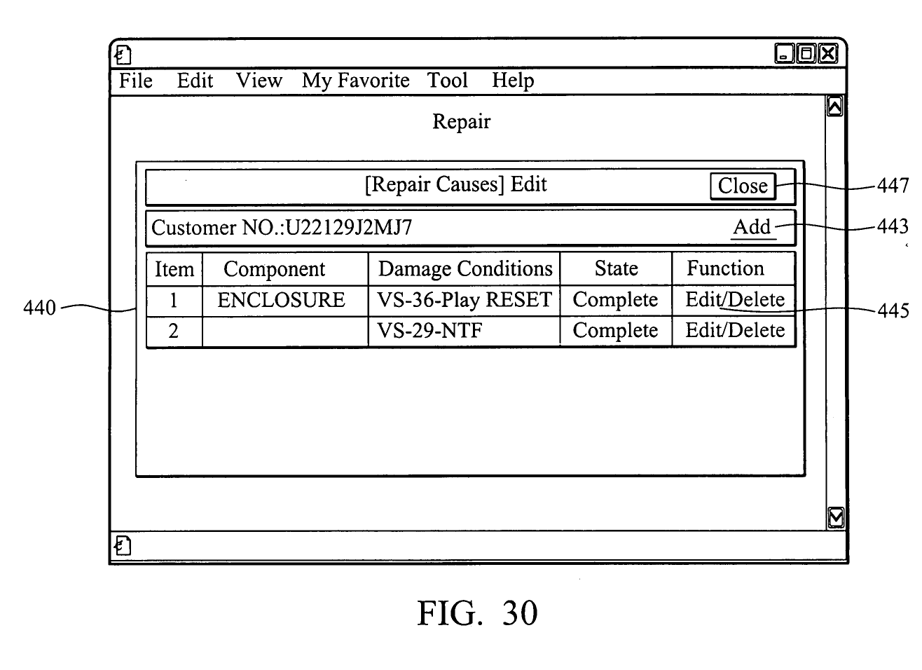

Next, Repair label 400 as shown in FIG. 1 is selected to enter a Repair interface 410, comprising a Main Menu 413, a Modify label 415, and an Inquiry label 417, as shown in FIG. 26. Inquiry label 417 is selected for inquiry of reparable RMA data, displaying an RMA inquiry section 420, comprising an RMA NO drop-down menu 423 and an Inquiry button 425, as shown in FIG. 27. A desired RMA number is selected and Inquiry button 425 is selected, displaying an RMA data table 430, listing reparable RMA data with customer numbers, as shown in FIG. 28. A desired customer number is selected, and a repair data table 435 thereof is displayed, as shown in FIG. 29, in which components of returned product are repaired or renewed according to fault conditions, defined by the sorting step, and reparable information is entered in corresponding fields of repair table 435. Next, the repair information must be confirmed before uploading into the database after the repair step, so that an Edit button 437 is selected, displaying a repair cause table 440, as shown in FIG. 30.

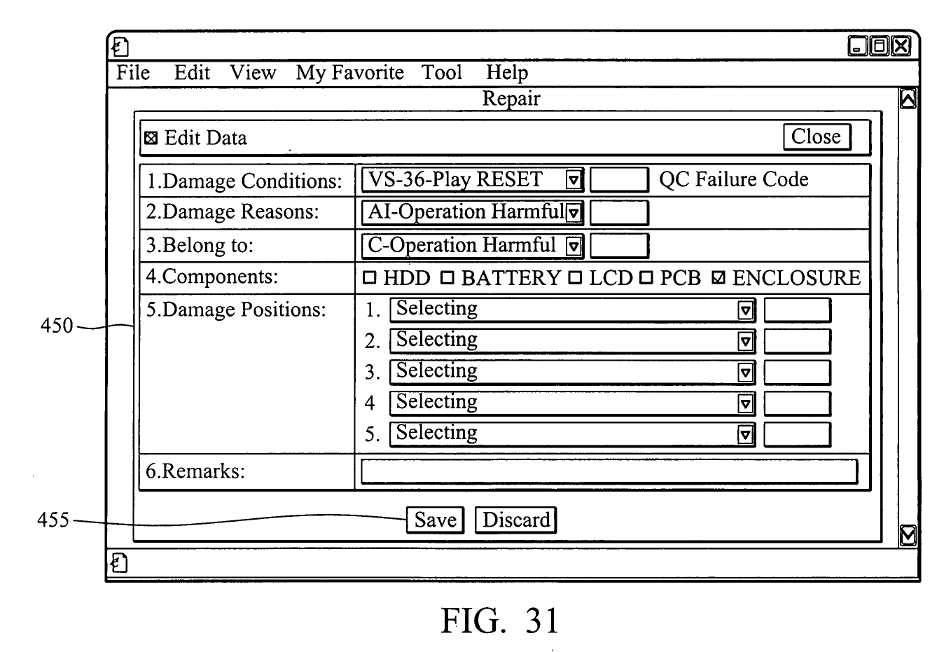

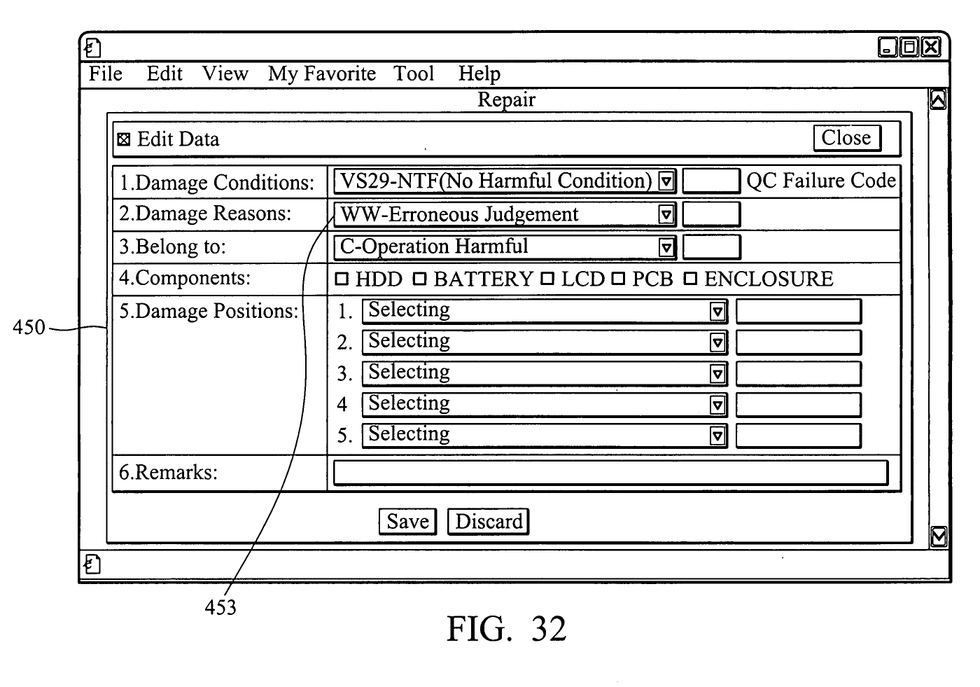

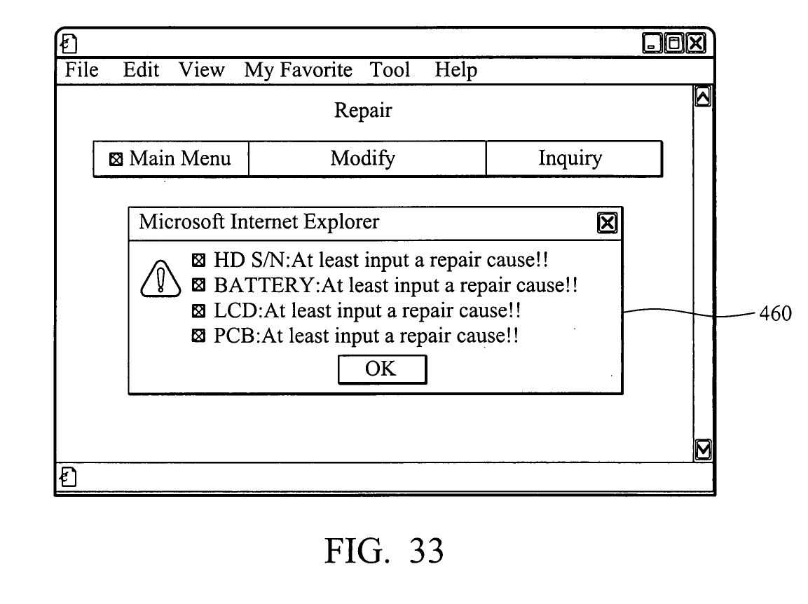

An Add button 443 is selected for addition of damage conditions. An Edit label 445 is selected for modification with incorrect damage condition determination, displaying a RMA data table 450 with damage conditions, as shown in FIG. 32, in which “Erroneous Judgment” in a Damage Reason drop-down menu 453 is selected and damage conditions are added in accordance with real conditions of returned product. In addition, repair information is added according to damage conditions with required replacement for the “ENCLOSURE” item, as shown in FIG. 31. A Save button 455 is selected to upload the modified data to the database, and the process goes back to Repair Cause table 440 shown in FIG. 30. A Close button 447 is selected, going back to repair table 435 as shown in FIG. 29, and a Save button 439 is selected with data accuracy confirmation, uploading repair data to the database. It is noted that an Error Message 460, as shown in FIG. 33, is displayed with other existing modifiable damage conditions or without listing in the Damage Position field, as shown in FIG. 31, with component replacement.

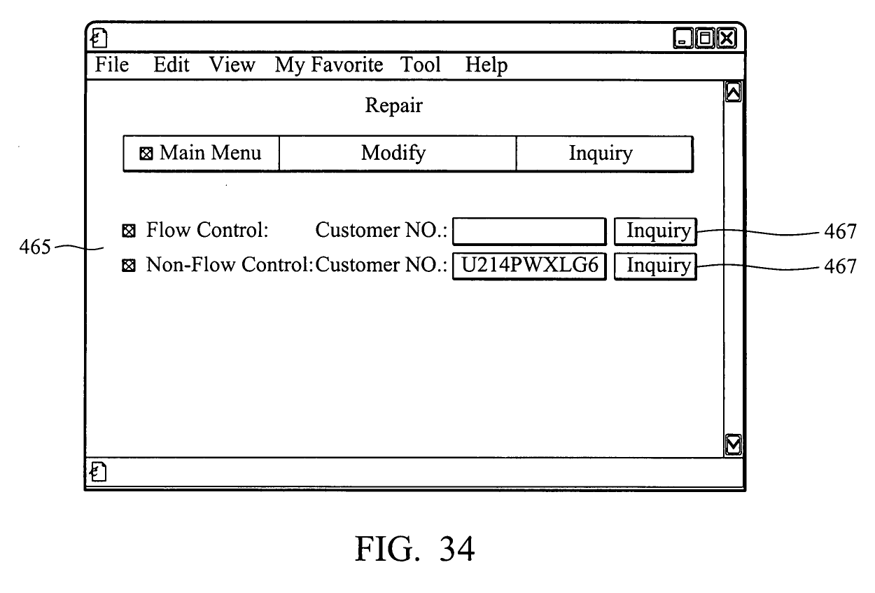

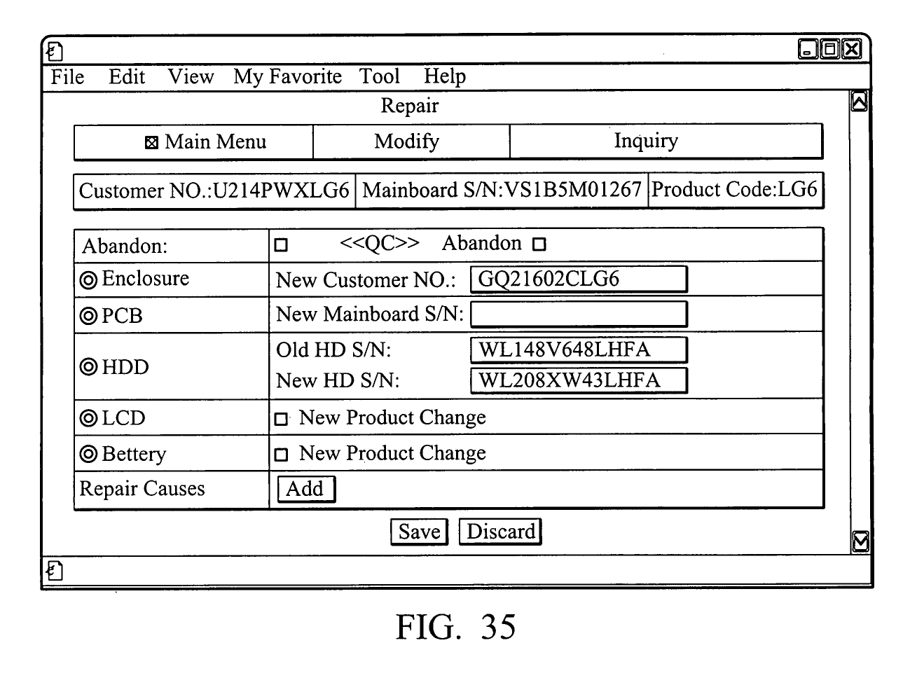

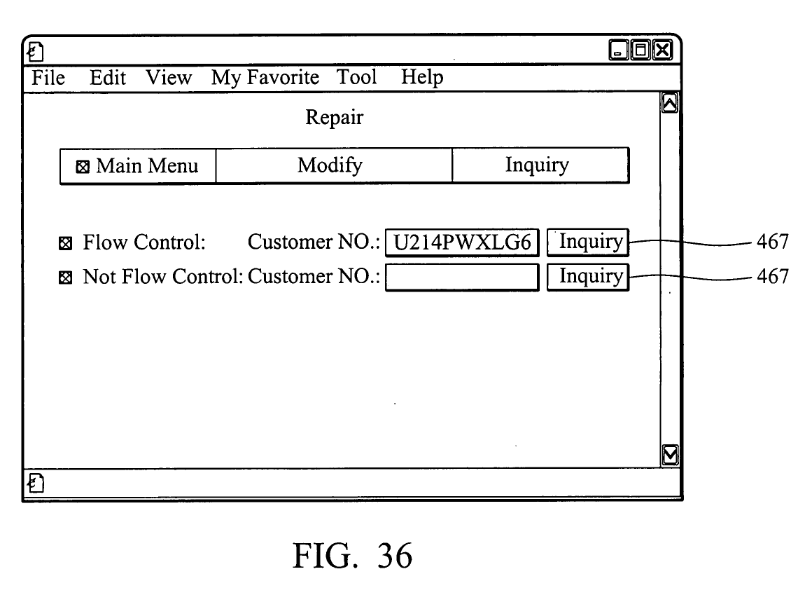

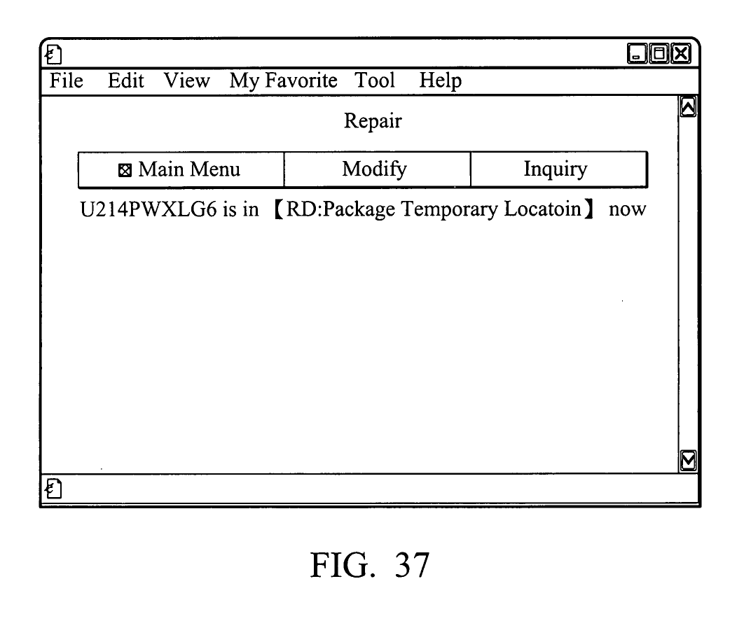

Modify label 415 is selected for modification of repair records, displaying an RMA data inquiry section 465. Inquiry methods comprise flow control and non-flow control, entering customer numbers in corresponding fields, as shown in FIG. 34 and FIG. 36 respectively, and clicking Inquiry buttons 467 to display related information, as shown in FIG. 35 and FIG. 37.

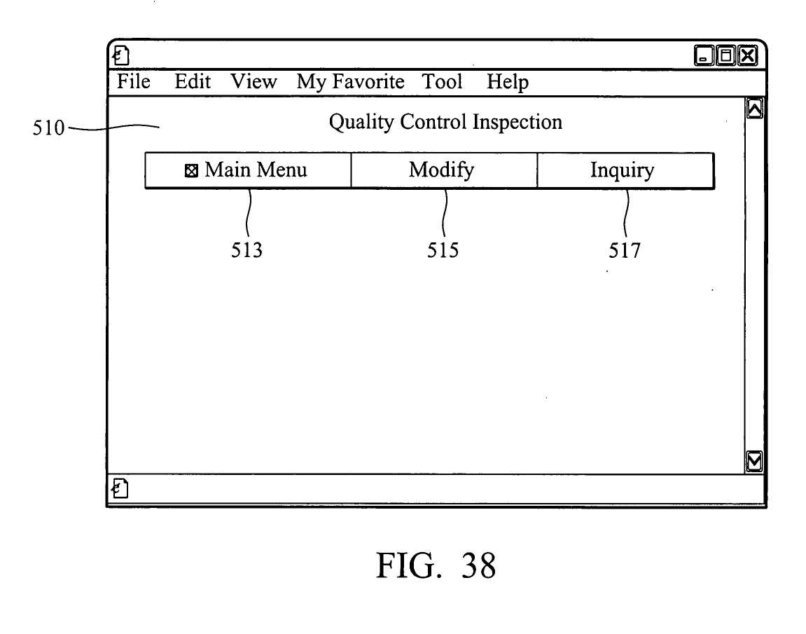

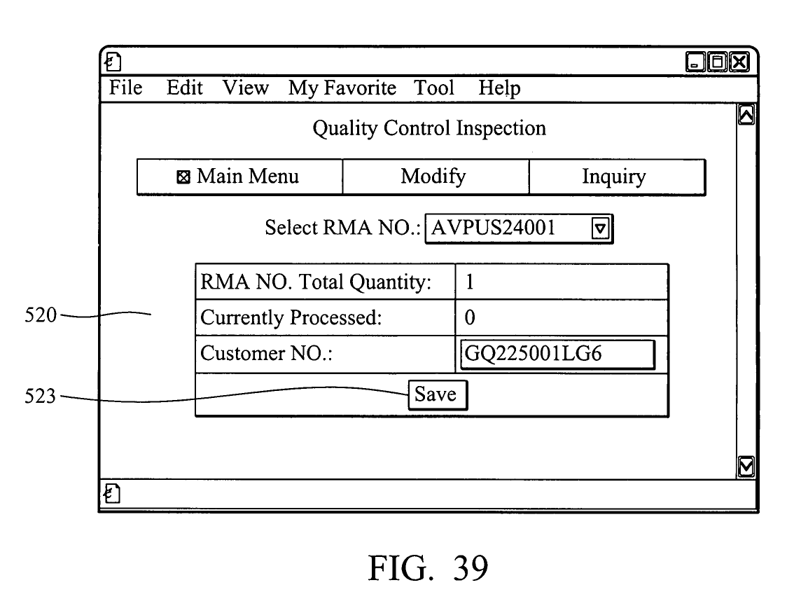

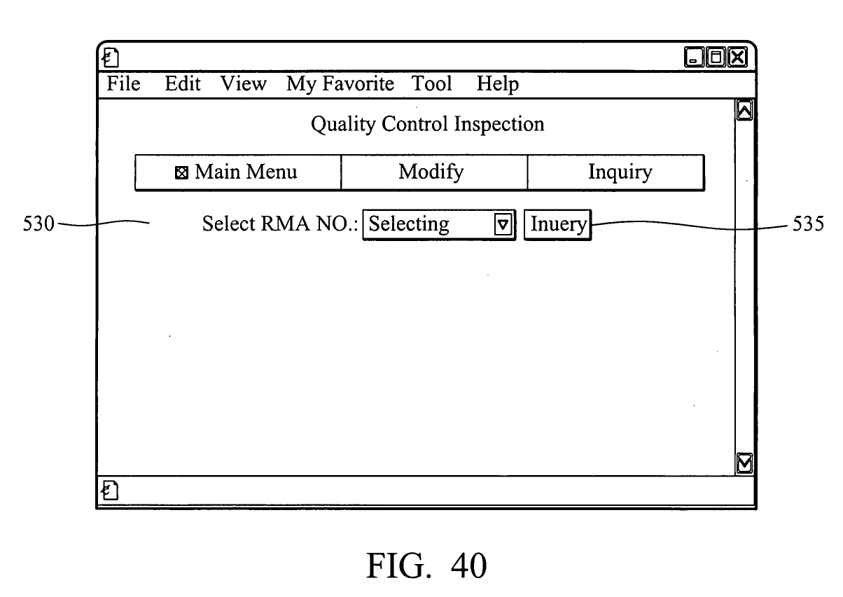

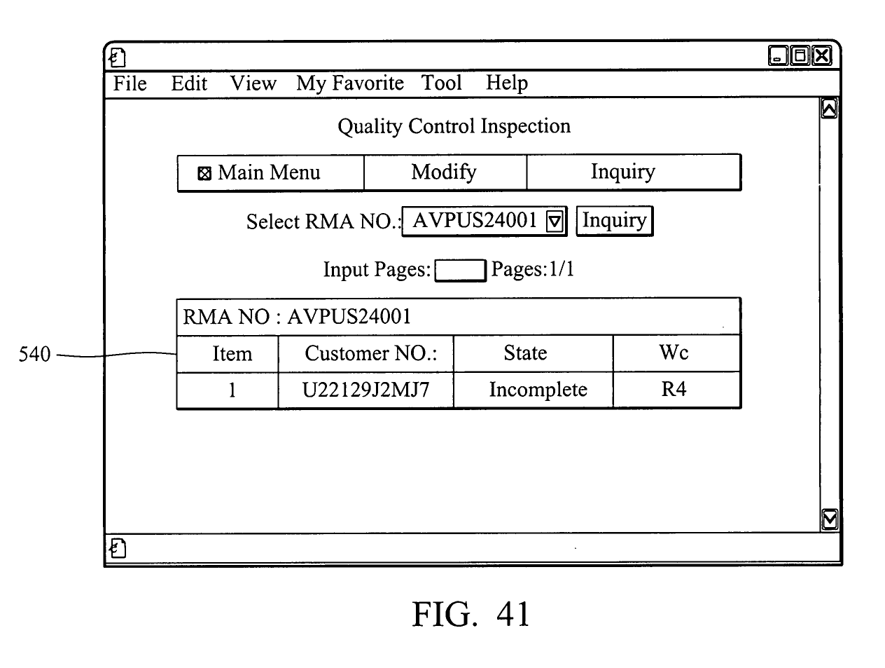

Next, Quality Control Inspection label 500, as shown in FIG. 1, is selected to enter a Quality Control Inspection interface 510, comprising a Main Menu 513, a Modify label 515, and an Inquiry label 517, as shown in FIG. 38. Modify label 515 is selected for modification of quality control inspection, displaying a Quality Control Inspection section 520, as shown in FIG. 39. A new customer number is automatically uploaded to the database after the Quality Control Inspection process is complete. A desired RMA number in a drop-down menu is selected, a customer serial number is entered in a Customer NO field, and a Save button 523 is selected to save the RMA data to the database. Inquiry label 517 is selected to inquire as to the state of the RMA data, displaying a Quality Control Inspection section 530, as shown in FIG. 40. A desired RMA number from a drop-down menu is selected and a Select button 535 is selected, displaying a corresponding RMA data table 540, indicating the state, complete or incomplete, of the RMA data of the Quality Control Inspection process, as shown in FIG. 41.

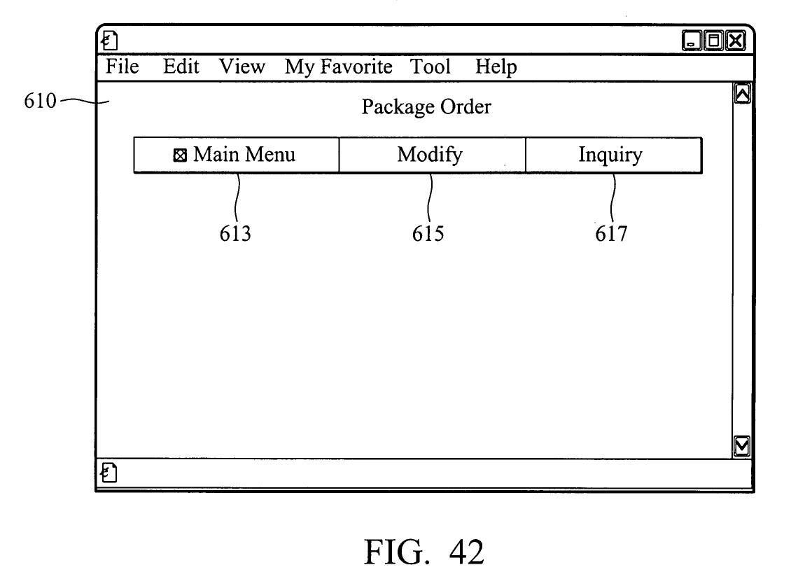

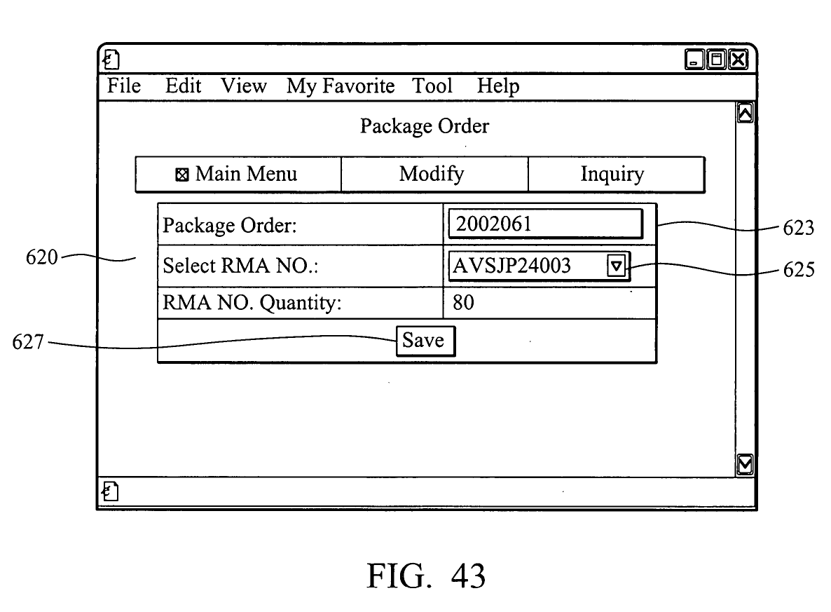

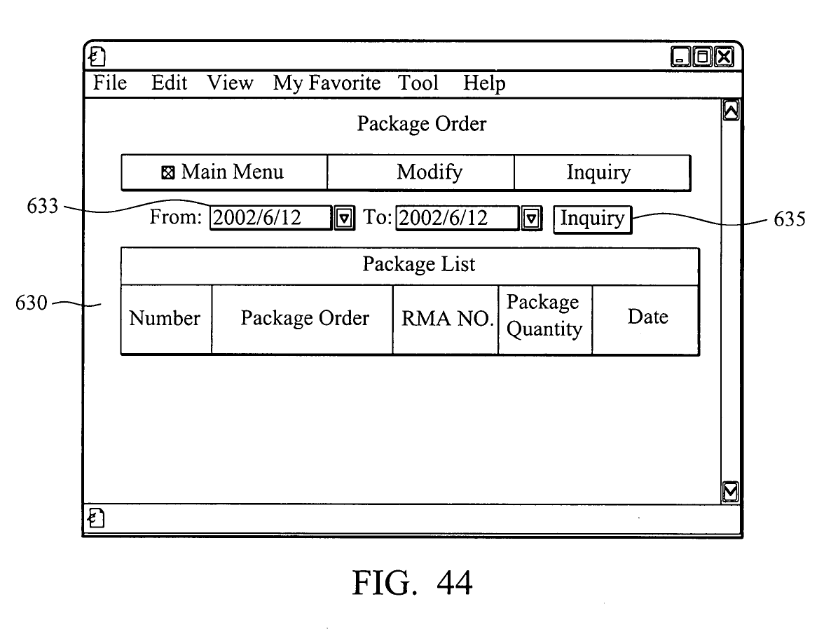

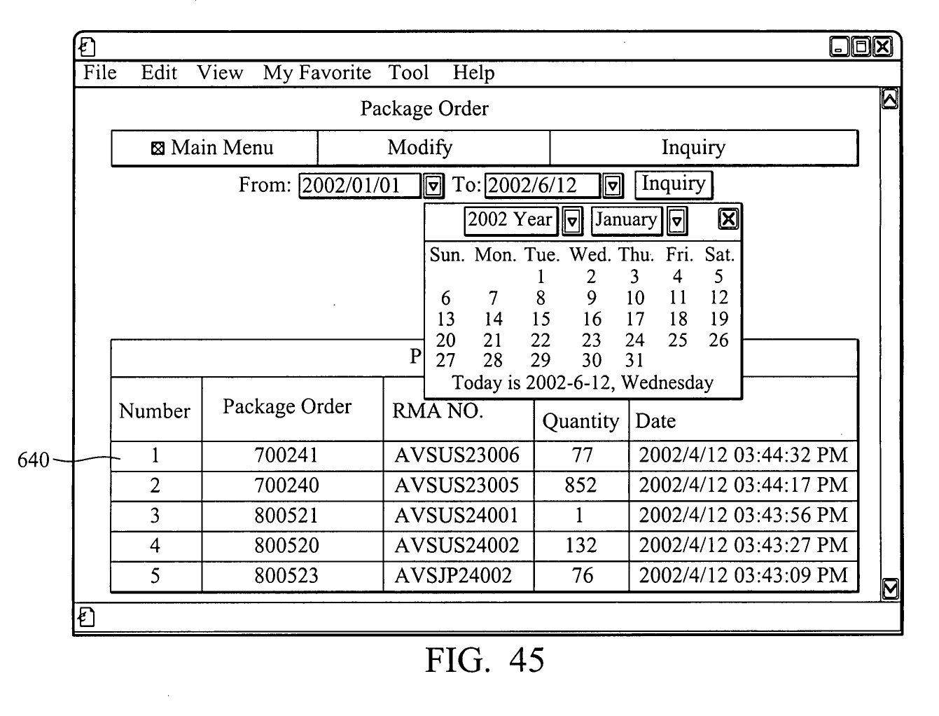

Next, Package Order label 600 as shown in FIG. 1 is selected to enter a Package Order interface 610, comprising a Main Menu label 613, a Modify label 615, and an Inquiry label 617, as shown in FIG. 42. Modify label 615 is selected for Package Order modification, displaying a Package Order data section 620, comprising a Package Order field 623, an RMA NO drop-down menu 625, and a Save button 627, as shown in FIG. 43. A Package Order number for the RMA data is entered in Package Order field 623, a desired RMA NO from a RMA NO drop-down menu 625 is selected, and a Save button 627 is selected, accomplishing the Package Order process. Inquiry label 617 is selected for Package Order inquiry within a period, displaying a Package Order inquiry section 630, as shown in FIG. 44. The start time and end times are selected from a date drop-down menu 633 and an Inquiry button 635 is selected, and a Package Order data table 640 is displayed, comprising related Package Order information for the RMA data, as shown in FIG. 45.

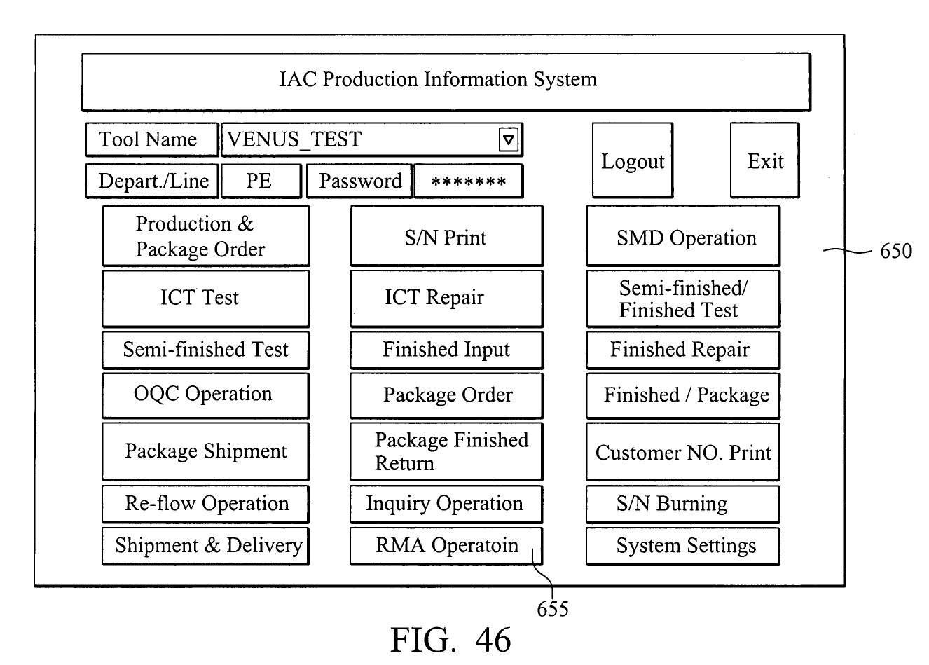

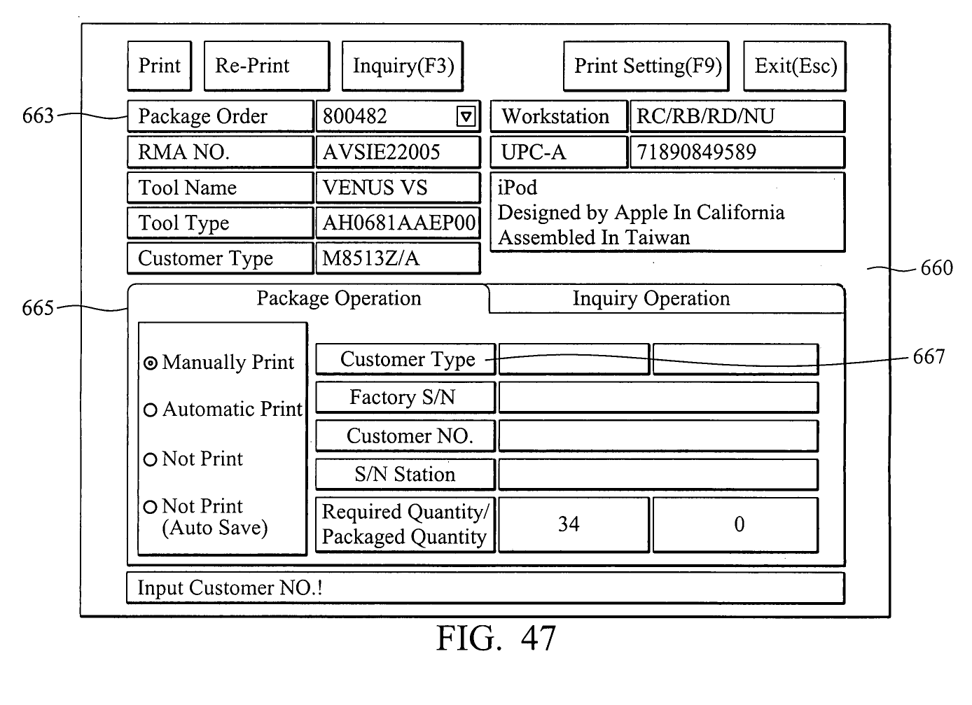

FIG. 46 is a schematic diagram showing a factory information system interface 650 according to the present invention. An RMA Operation label 655 is selected for package and shipment, entering an RMA Operation interface 660, as shown in FIG. 47. A desired Package Order number is selected from a Package Order drop-down menu 663, displaying information related to the package order, and the desired customer number is input, with correct Package Order information, in a Customer NO field 667 included in a Package Operation page 665.

For an RMA factory information system, data regarding type codes, component names, country codes, condition codes, and others, have to be established in a database to accommodate different conditions. Output reports are also uploaded into the database for reference. Thus, the invention provides a method for replacing manual operations with automated procedures, saving time and increasing product reliability and customer satisfaction.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of automated repair and control operation, comprising steps of:
creating an RMA number after receiving an RMA request form for returned product;
uploading RMA data of the returned product to a database of a factory information system and then verifying the RMA data;
checking whether claimed defects of the returned product are accurate;
repairing the returned product according to the claimed defects with correct checking thereof;
inspecting the returned product to ensure that the repair step is complete; and
packaging and shipping the repaired returned product.

2. The method as claimed in claim 1, wherein data files of the returned product, comprising *.xls files, are converted to readable files, comprising *.cvs, compatible with an RMA system.

3. The method as claimed in claim 1, wherein RMA data of the returned product comprises at least a customer number.

4. A system of automated repair and control operation, comprising:
a plurality of hierarchical interfaces, of which at least one comprises a series of returned product and at least one is functionally capable of receiving each input returned product.

5. The system as claimed in claim 4, wherein the hierarchical interfaces comprise an RMA NO Generation interface, creating an RMA number according to the received returned product and adding, inquiring as to, or editing RMA data returned product for requirements.

6. The system as claimed in claim 5, wherein the hierarchical interfaces comprise an Upload interface, uploading RMA data to the database and adding, inquiring as to, or editing the RMA data for requirements.

7. The system as claimed in claim 6, wherein the hierarchical interfaces comprise a Quality Control Data Sorting interface, checking claimed defects of the returned product and inquiring as to, or editing the RMA data for requirements.

8. The system as claimed in claim 7, wherein the hierarchical interfaces comprise a Repair interface, recovering the claimed defects of the returned product and inquiring as to or editing the RMA data if necessary.

9. The system as claimed in claim 8, wherein the hierarchical interfaces comprise a Quality Control Inspection interface, determining whether the claimed defects is changed and inquiring as to or editing the RMA data for requirements.

10. The system as claimed in claim 10, wherein the hierarchical interfaces comprise a Package Order interface, packaging the repaired returned product and inquiring as to or editing the RMA data for requirements.

11. The system as claimed in claim 4, wherein the hierarchical interfaces comprise a system setup interface, creating suitable settings for the RMA data in accordance with different processes.

12. The system as claimed in claim 4, wherein the hierarchical interfaces comprise a Report interface, outputting reports of the RMA data.

13. The system as claimed in claim 4, wherein the hierarchical interfaces comprise at least a Main Menu label and a Modify label, returning to the main interface and modifying related data of the returned product, separately.

14. The system as claimed in claim 4, wherein each modifying section comprises a drop-down menu, displaying all returned product.

15. The system as claimed in claim 4, wherein the hierarchical interfaces comprise a damage condition editing section, including all damage conditions for the returned product.

16. The system as claimed in claim 4, wherein the hierarchical interfaces comprise a plurality of drop-down menus, displaying a plurality of RMA numbers, inquiring repair conditions for the returned product.

17. The system as claimed in claim 4, wherein the hierarchical interfaces comprise at least one date menu, displaying all received RMA numbers within a period.

18. A system of automated repair and control operation, comprising:
a database storage system; and
a plurality of hierarchical interfaces related to returned product, directly or indirectly communicating with the database storage system, in which at least one interface comprises at least a modifiable data input field, modifying the returned product stored in the database storage system.

19. The system as claimed in claim 18, wherein customer numbers of the returned product are uploaded to the database storage system.

20. The system as claimed in claim 18, wherein the hierarchical interfaces comprise a Repair interface, including repair information of the returned product, entered in corresponding fields and then recorded in the database storage system.
